(19) United States
(12) Patent Application Publication
(10) Pub. No.: US 2010/0164887 A1
(43) Pub. Date: Jul. 1, 2010

(54) ELECTRONIC APPARATUS AND INPUT CONTROL METHOD

(75) Inventor: Toshikatsu NAKAMURA, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/608,841

(22) Filed: Oct. 29, 2009

(30) Foreign Application Priority Data
Dec. 26, 2008 (JP) 2008-333953

(51) Int. Cl. G06F 3/041

(52) U.S. Cl. 345/173

(57) ABSTRACT

According to one embodiment, an electronic apparatus includes a touch pad, a detection module configured to detect a plurality of positions which are pointed on the touch pad, a determination module configured to determine whether a specific function is assigned to a combination of the plurality of positions, and a execution module configured to execute the specific function when the determination module determines that the specific function is assigned to the combination of the plurality of positions.

### CROSS-REFERENCE TO RELATED APPLICATIONS

This application is based upon and claims the benefit of priority from Japanese Patent Application No. 2008-333953, filed Dec. 26, 2008, the entire contents of which are incorporated herein by reference.

### BACKGROUND

1. Field

One embodiment of the invention relates to an electronic apparatus which is provided with a coordinate input device such as a touch pad, and also relates to an input control method.

2. Description of the Related Art

In general, in a notebook personal computer, a touch pad, which functions as a coordinate input device, is provided as a pointing device on the top surface of the housing of the main body. In usual cases, the touch pad is disposed on a substantially central part of a palm rest which is provided on the front side of a keyboard. Thereby, in the state in which the hands are placed on the palm rest in order to perform an input operation on the keyboard, an input operation can also be performed easily on the touch pad.

On the other hand, since the touch pad is disposed at such a position that the input operation is easy, the touch pad, in some cases, may erroneously be touched during the operation of the keyboard. In such cases, a process, which is not intended by the user, is executed by the input on the touch pad, leading to deterioration in operability. For example, in the case where the touch pad is touched during a key input, it is possible that the pointer (mouse cursor) on the screen is moved and the character input position is moved.

In the prior art, in order to prevent an erroneous operation on the touch pad, the enabling/disabling of data that is input from the touch pad can be switched. Jpn. Pat. Appln. KOKAI Publication No. 2008-4000, for instance, discloses a personal computer which is configured such that contact detectors are provided on both sides of the touch pad on the palm rest, and the input of the touch pad is disabled in the case where the touch by the hand is detected by the two contact detectors.

As described above, in the prior art, in order to control the enabling/disabling of the input on the touch pad, it is necessary to provide dedicated input devices such as contact detectors. This increases the number of dedicated parts, which constitute the personal computer, and the number of fabrication steps, leading to an increase in cost.

In addition, if the two contact detectors are unintentionally touched by the hand, the input from the touch pad would be disabled. Conversely, if the hand is detached from any one of the contact detectors, the input from the touch pad would be enabled, and there is a concern that an erroneous operation is executed on the touch pad during an input operation on the keyboard.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a personal computer according to an embodiment of the present invention;

FIG. 2 is an exemplary block diagram showing the system configuration of the personal computer according to the embodiment;

FIG. 3 is an exemplary structural diagram relating to an input control of a touch pad in the personal computer according to the embodiment;

FIG. 4 show examples of a pointing operation on the touch pad in the embodiment;

FIG. 5 is an exemplary flow chart illustrating a touch pad control process in the embodiment;

FIG. 6A and FIG. 6B show examples of the operation on the touch pad in the embodiment;

FIG. 7 is an exemplary flow chart illustrating a setting process by a utility in the embodiment;

FIG. 8 shows an example of a touch pad setting screen in the embodiment;

FIG. 9A and FIG. 9B show examples of the operation on the touch pad in the embodiment;

FIG. 10A and FIG. 10B show examples of the operation on the touch pad in the embodiment;

FIG. 11A, FIG. 11B and FIG. 11C show examples of a display screen in the embodiment; and

FIG. 12 shows an example of data which is set in connection with a plurality of control functions in the embodiment.

### DETAILED DESCRIPTION

Various embodiments according to the invention will be described hereinafter with reference to the accompanying drawings. In general, according to one embodiment of the invention, there is provided an electronic apparatus comprising: a touch pad configured to detect a plurality of positions of objects on the touch pad; a determination module configured to determine whether a predetermined function is assigned to a combination of the plurality of positions; and an execution module configured to execute the predetermined function when the determination module determines that the predetermined function is assigned to the combination of the plurality of positions.

An embodiment of the present invention will now be described with reference to the accompanying drawings.

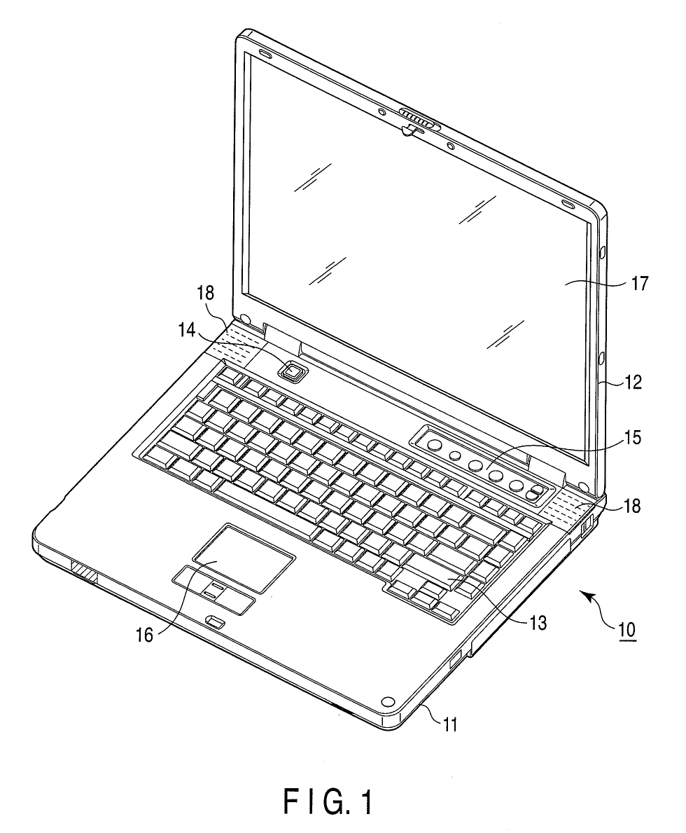

The electronic apparatus of this embodiment is realized, for example, as a notebook personal computer 10 shown in FIG. 1.

The electronic apparatus of the present invention is not limited to the personal computer 10, and may be any apparatus in which a processor for executing programs is mounted and a pointing device, such as a touch pad, which can simultaneously point a plurality of positions, is provided. Examples of the electronic apparatus include a mobile phone, a PDA (personal digital assistant), a portable audio/video player, a digital video camera, and a portable car navigation apparatus.

FIG. 1 is a perspective view showing the personal computer 10 in the state in which a display unit thereof is opened. The personal computer 10 is composed of a computer main body 11 and a display unit 12. A display device, which is composed of an LCD (Liquid Crystal Display) 17, is built in the display unit 12.

The display unit 12 is attached to the computer main body 11 such that the display unit 12 is rotatable between an open position where the top surface of the computer main body 11 is exposed, and a closed position where the top surface of the computer main body 11 is covered. The computer main body 11 has a thin box-shaped housing. A keyboard 13, a power button 14 for power-on/power-off, an input operation panel 15, a touch pad 16, and speakers 18 are disposed on the top surface of the housing of the computer main body 11.

The input operation panel 15 is an input device for inputting an event corresponding to a pressed button. The input operation panel 15 includes a plurality of buttons for activating a plurality of functions.

In the personal computer 10 of the present embodiment, the touch pad 16 is provided on a so-called palm rest on the front side of the keyboard 13 on the top surface of the computer main body 11. In the example shown in FIG. 1, the touch pad 16 is provided at a substantially central part in the lateral width direction on the top surface of the computer main body 11. The touch pad 16 is usually a pointing device which is touched by a user's finger tip to input coordinate data.

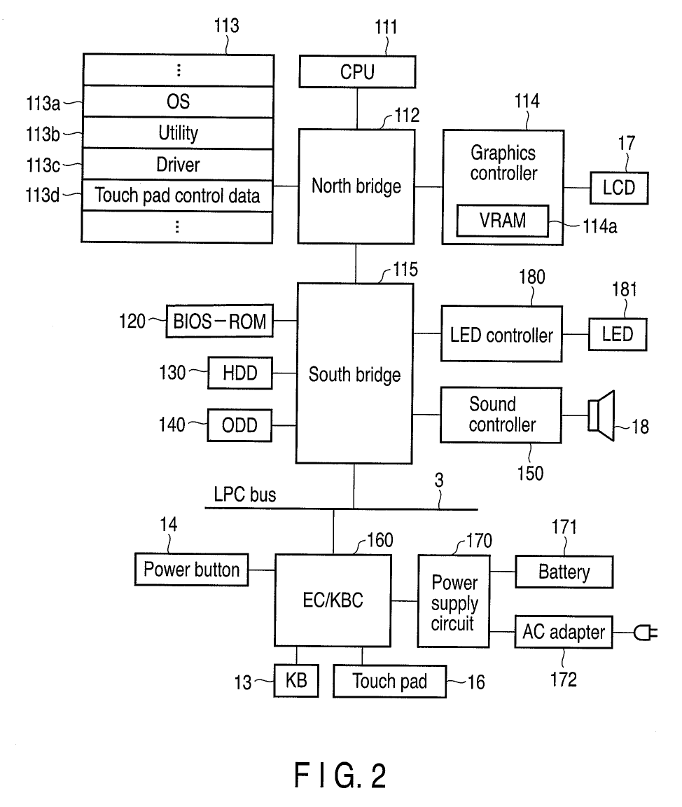

FIG. 2 is a block diagram showing the system configuration of the computer main body 11. The computer main body 11 includes a CPU 111, a north bridge 112, a main memory 113, a graphics controller 114, and a south bridge 115. The computer main body 11 further includes a BIOS-ROM 120, a hard disk drive (HDD) 130, an optical disc drive (ODD) 140, a sound controller 150, an embedded controller/keyboard controller IC (EC/KBC) 160, and a power supply circuit 170.

The CPU 111 is a processor for controlling the operation of the personal computer 10. The CPU 111 executes an operating system (OS) 113a which is loaded from a boot device, e.g. the HDD 130, into the main memory 113. In addition, the CPU 111 executes various application programs. Besides, the CPU 111 executes a system BIOS (Basic Input/Output System) that is stored in the BIOS-ROM 120. The system BIOS is a program for hardware control.

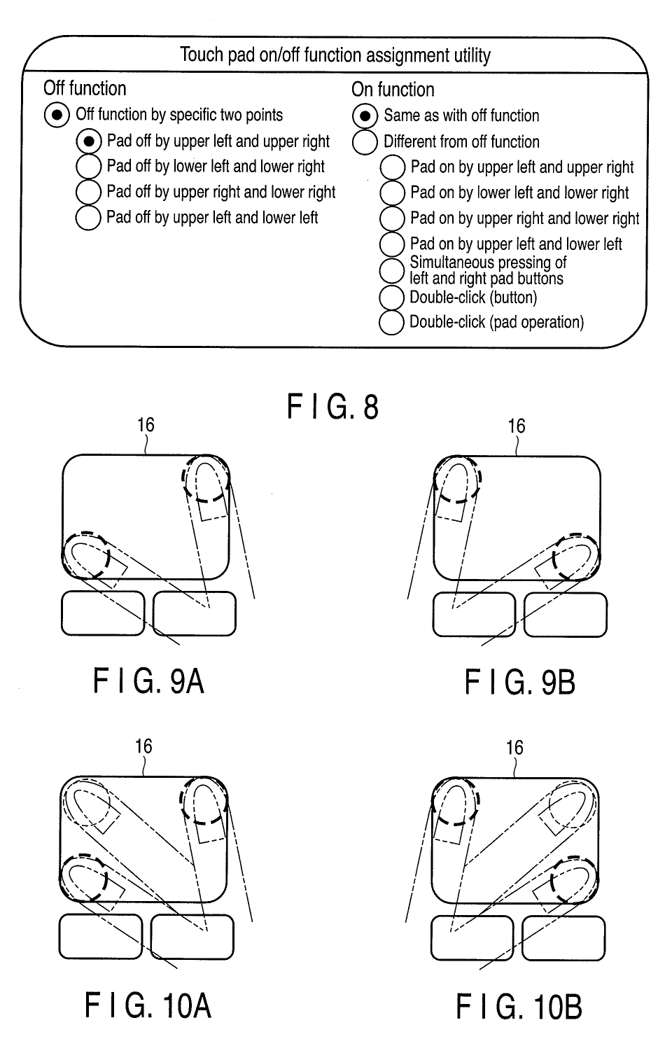

In the personal computer 10 of this embodiment, a utility 113b is prepared for setting touch pad control data 113d for input control on the touch pad 16 (the details are shown in FIG. 7 and FIG. 8). Combinations of a plurality of positions, which are designated by a pointing operation on the touch pad 16, and specific functions, which are executed in association with the combinations, are defined in the touch pad control data 113d. The specific functions are predetermined to include, for example, a function of enabling (ON) or disabling (OFF) of a pointing operation on the touch pad 16. The driver 113c executes input control of the touch pad 16. On the basis of a signal which is input via the EC/KBC 160, the driver 113c detects a position which is pointed on the touch pad 16. In addition, the driver 113c detects a plurality of positions which are simultaneously pointed on the touch pad 16. By a touch pad control process (to be described later), the driver 113c determines whether the combination of plural positions, which are simultaneously detected on the touch pad 16, is preset in the touch pad control data 113d, and executes a process corresponding to the specific function which is set in association with this combination of plural positions. The details will be described later.

The north bridge 112 is a bridge device that connects a local bus of the CPU 111 and the south bridge 115. The north bridge 112 includes a memory controller that access-controls the main memory 113. The north bridge 112 also has a function of executing communication with the graphics controller 114.

The graphics controller 114 is a display controller which controls the LCD 17 that is used as a display monitor of the computer 10. The graphics controller 114 includes a video memory (VRAM) 114a, and generates a video signal, which forms a display image that is to be displayed on the LCD 17, on the basis of display data that is written in the video memory 114a.

The south bridge 115 controls access to the BIOS-ROM 120. The BIOS-ROM 120 is a rewritable nonvolatile memory such as a flash ROM. As described above, the BIOS-ROM 120 stores the system BIOS. In addition, the south bridge 115 controls disc drives (I/O devices) such as the HDD 130 and ODD 140. In addition, the south bridge 115 controls various devices on an LPC bus 3.

The HDD 130 is a storage device which stores various programs and data. In the HDD 130, data write/read is executed on a magnetic disk which is rotated by a motor. The HDD 130 prestores programs such as the operating system (OS), drivers and utilities. The OS is loaded in the main memory 113 according to the system BIOS that is stored in the BIOS-ROM 120, and is executed by the CPU 111. Other programs, such as drivers and utilities, and data are loaded in the main memory 113, where necessary, and are executed by the CPU 111.

The ODD 140 is a drive unit which rotates and drives optical discs, such as a compact disc (CD) and a digital versatile disc (DVD), by means of a motor. The ODD 140 executes data read/write on optical discs.

The sound controller 150 executes control to produce sound from the speaker 18. For example, the sound controller 150 produces sound from the speaker 18 in accordance with input control on the touch pad 16.

The EC/KBC 160 is a microcomputer in which an embedded controller for power management and a keyboard controller for controlling the keyboard (KB) 13 and touch pad 16 are integrated in a single chip. The EC/KBC 160 has a power control function of cooperating with the power supply circuit 170, thereby powering on the computer 10 in response to the user's operation of the power button switch 14.

The power supply circuit 170 uses DC power which is supplied from a rechargeable battery 171 or from an AC adapter 172 functioning as a high voltage power supply, thereby generating system power supply voltages which are to be applied to the respective components of the computer main body 11. The AC adapter 172 converts AC power to DC power.

Although not shown, a communication function, such as a wireless LAN, is provided.

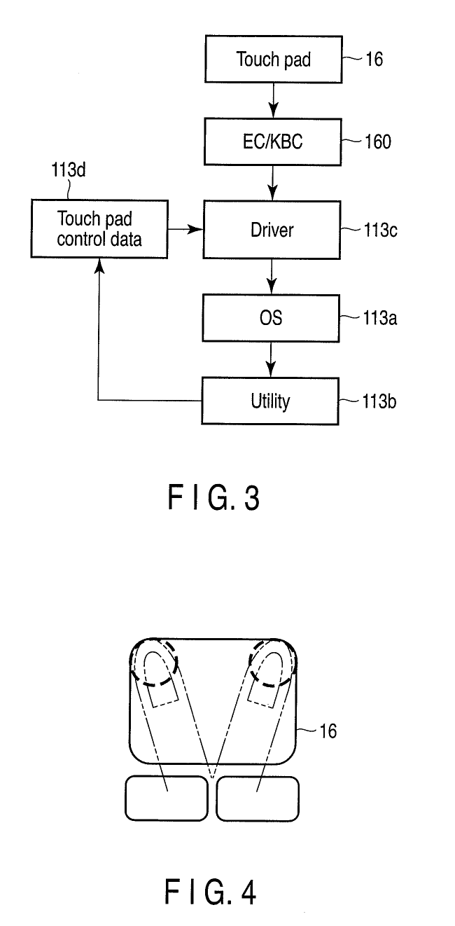

FIG. 3 is a structural diagram relating to an input control of the touch pad 16 in the personal computer 10 according to the embodiment.

The EC/KBC 160 controls the input from the touch pad 16. On the basis of a signal which is input via the EC/KBC 160, the driver 113c detects coordinate data which is indicative of a position that is designated by a pointing operation on the touch pad 16. In addition, in the case where a plurality of positions are designated by the pointing operation, the driver 113c determines whether the combination of the designated positions corresponds to the combination of plural positions, which is preset in the touch pad control data 113d. If it is determined that the combination of the designated positions corresponds to the preset combination, the driver 113c executes a process corresponding to the specific function which is associated with the combination of plural positions. In the case of the function of turning on (enabling) the input from the touch pad 16, the driver 113c outputs coordinate data, which is detected by the touch pad 16, to the OS 113a. In the case of the function of turning off (disabling) the input from the touch pad 16, the driver 113c prohibits the output of coordinate data, which is detected by the touch pad 16, to the OS 113a. Besides, in the case of where the specific function, which is set in association with the combination of plural positions, relates to a control associated with other device, the driver 113c outputs a code indicative of the corresponding function to the OS 113a.

In accordance with the code from the driver 113c, the OS 113a controls the function which is designated by the pointing operation on the plural positions. Examples of the functions include, in addition to the above-described ON/OFF control function of the touch pad 16, an ON/OFF control of the backlight of the LCD 17, and an ON/OFF control of a suspend function.

In addition, in the case where the setting of the input control on the touch pad 16 has been requested, the OS 113a activates the utility 113b. The utility 113b causes the LCD 17 to display a setting screen, accepts a setting request from the user, and stores the touch pad control data 113d corresponding to the setting content.

FIG. 4 shows an example of the operation of simultaneously pointing a plurality of positions on the touch pad 16 in the present embodiment. In the personal computer 10 of the present embodiment, if a simultaneous pointing operation is executed on a plurality of positions which are preset in the touch pad control data 113d, the function, which is set in association with the combination of the simultaneously pointed positions, is executed. FIG. 4 shows an operation example in the case where a combination of two points at an upper left corner and an upper right corner (hereinafter referred to simply as “upper left and right”) of the touch pad 16. In this case, it is assumed that a specific function of switching ON (enabling) and OFF (disabling) of the touch pad 16 is assigned to the combination of the two points of the upper left and right of the touch pad 16.

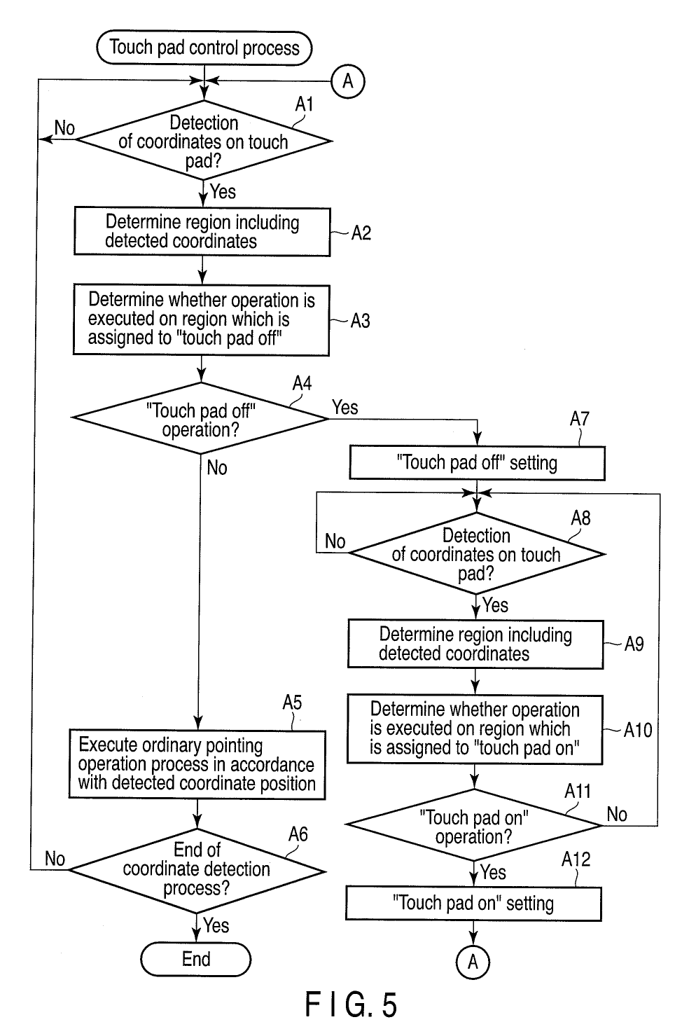

Next, referring to a flow chart of FIG. 5, a description is given of the touch pad control process by taking the pointing operation of FIG. 4 as an example.

The CPU 111 executes the touch pad control process by the driver 113c. In this process, even in the case where a plurality of positions are simultaneously pointed on the touch pad 16, each of the pointed positions is detected. Thus, in the case where the pointing operation, as shown in FIG. 4, is executed on the touch pad 16, the CPU 111 detects the coordinate data indicative of the two simultaneously pointed positions. If the coordinate data of two points are simultaneously detected (Yes in block A1), the CPU 111 determines regions including the detected coordinate data (block A2).

In the case where the combination of the upper left and right points of the touch pad 16, which is shown in FIG. 4, is set in the touch pad control data 113d, it is determined whether the coordinate data which is detected by the touch pad 16 is included in each of a first region corresponding to the upper left of the touch pad 16 and a second region corresponding to the upper right of the touch pad 16. In FIG. 4, the first region and the second region are indicated by broken-line circles.

On the basis of the combination of the regions (positions) including the coordinate data of the two points detected by the touch pad 16, the CPU 111 determines whether the pointing operation is executed on the regions (first region, second region) which are assigned to the function of turning off (disabling) the input of the touch pad 16 (block A3).

If it is determined that the pointing operation is not the operation of turning off the input of the touch pad 16 (No in block A4), the CPU 111 executes a process corresponding to an ordinary pointing operation in accordance with the coordinate position detected on the touch pad 16 (block A5). For example, the driver 113c reports to the OS 113a the coordinate data of the position pointed on the touch pad 16. The OS 113a, for example, moves the position of the cursor which is displayed on the LCD 17, in accordance with the coordinate data which is reported from the driver 113c.

The CPU 111 continuously executes the above-described process by the driver 113c until the process of detecting the coordinate data on the touch pad 16 is finished (Yes in block A6).

On the other hand, if the pointing operation of turning off the input of the touch pad 16 is determined (Yes in block A4), the CPU 111 executes touch pad OFF setting for turning off (disabling) the input on the touch pad 16 (block A7). Specifically, the driver 113c disables the coordinate data that is detected by the signal from the EC/KBC 160, and does not report the coordinate data to the OS 113a.

In the case where the touch pad OFF setting has been effected, if coordinate data of two points are simultaneously input by a pointing operation on the touch pad 16 and are detected (block A8), the CPU 111 determines regions including the detected coordinate data. In this example, the specific function of switching ON (enabling) and OFF (disabling) of the touch pad 16 is assigned to the combination of the two points of the upper left and right of the touch pad 16, as shown in FIG. 4. Thus, in the same manner as described above, the CPU 111 determines whether the detected coordinate data are included in the first region and the second region (block A9).

On the basis of the combination of the regions (positions) including the coordinate data of the two points detected by the touch pad 16, the CPU 111 determines whether the pointing operation is executed on the regions (first region, second region) which are assigned to the function of turning on (enabling) the input of the touch pad 16 (block A10).

If it is determined that that the pointing operation is not the operation of turning on the input of the touch pad 16 (No in block A11), the CPU 111 continues the state in which the touch pad OFF setting is effected (blocks A8 to A11). Specifically, the driver 113c disables the coordinate data that is detected on the touch pad 16, and does not report the coordinate data to the OS 113a.

On the other hand, if the pointing operation of turning on the touch pad 16 is determined (Yes in block A11), the CPU 111 executes touch pad ON setting for turning on (enabling) the input on the touch pad 16 (block A12). Specifically, the driver 113c enables the coordinate data that is detected by the signal from the EC/KBC 160, and switches control to report the coordinate data to the OS 113a.

Subsequently, as described above, in the case where a pointing operation is simultaneously executed on the upper left and right positions on the touch pad 16, the specific function of disabling the input of the touch pad 16 is executed. When other pointing operations are executed, an ordinary pointing operation process corresponding to a position that is designated on the touch pad 16 is executed. Specifically, each time the pointing operation shown in FIG. 4 is executed, the ON (enabling)/OFF (disabling) of the touch pad 16 is switched.

As has been described above, in the personal computer 10 of the present embodiment, the ON (enabling)/OFF (disabling) of the touch pad 16 can be switched by the pointing operation on the upper left and right positions on the touch pad 16. In usual cases, during the key input operation on the keyboard 13 or during the operation on the touch pad 16, the possibility is low that a plurality of preset positions, as shown in FIG. 4, are erroneously touched at the same time. Therefore, the specific function can surely be executed by the pointing operation on the touch pad 16, and the specific function is not executed by an erroneous operation.

In the personal computer 10 of the present embodiment, since the execution of the specific function can be controlled by using the touch pad 16 which is a conventional one, there is no need to add to the personal computer 10 a purpose-specific component that is used for function switching, thus causing no increase in cost. In addition, it should suffice to execute a simultaneous pointing operation in a predetermined number of plural regions which are preset on the touch pad, and there is no need to execute a special operation. Therefore, anyone can easily instruct the execution of a specific function.

In the above-described example, the pointing operation is simultaneously executed on the upper left and right corner positions on the touch pad 16, as shown in FIG. 4. However, specific functions may be assigned to other combinations of plural positions.

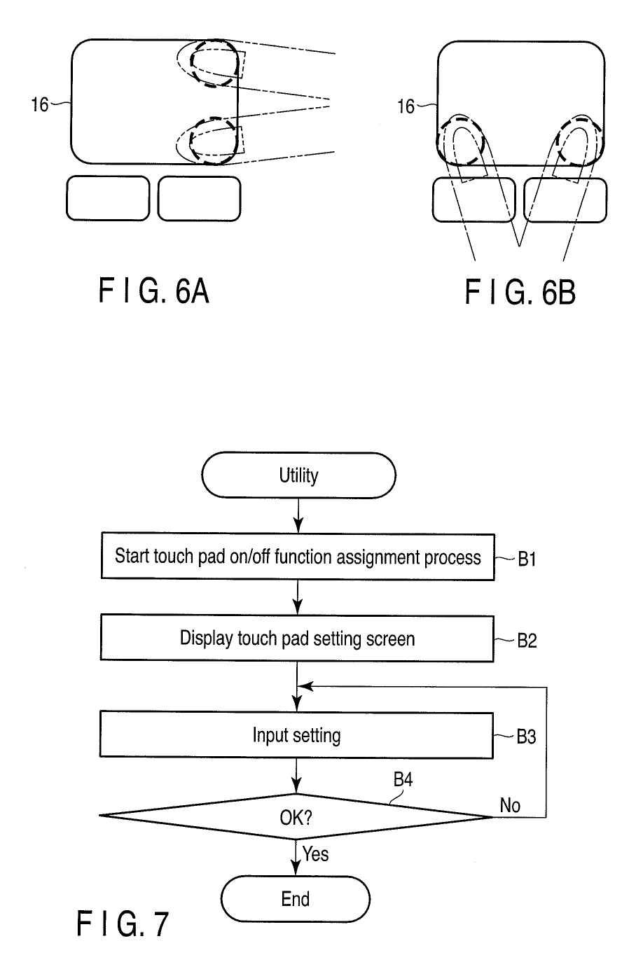

FIG. 6A shows an example in which a specific function is assigned to a combination of an upper right position and a lower right position on the touch pad 16. FIG. 6B shows an example in which a specific function is assigned to a combination of a lower left position and a lower right position on the touch pad 16. Other combinations of plural positions can be used.

Besides, in the personal computer 10 of the present embodiment, combinations of plural positions for the user to instruct the execution of an arbitrary specific function can be set by the utility 113b.

FIG. 7 is a flow chart illustrating the setting process by the utility 113b. FIG. 7 shows an example of setting the combinations of plural positions on the touch pad 16, to which the function of switching ON (enabling)/OFF (disabling) of the touch pad 16 is assigned.

To begin with, if the execution of the utility 113b is instructed by the user, the CPU 111 starts a touch pad ON/OFF function assignment process, and causes the LCD 17 to display a touch pad setting screen (block B1, B2).

FIG. 8 shows an example of the touch pad setting screen. In the example of the touch pad setting screen shown in FIG. 8, combinations of plural positions on the touch pad 16 can be selected with respect to the OFF function and ON function of the touch pad 16, respectively.

For example, in the case where the OFF function is executed by the simultaneous pointing operation on two points, one of a plurality of preset combinations of plural positions, namely, upper left and right, lower left and right, upper and lower right, and upper and lower left, can be selected. For instance, in the case where “PAD OFF BY UPPER LEFT AND UPPER RIGHT” in FIG. 8 is selected, control can be executed to turn off (disable) the input of the touch pad 16 in the case where a simultaneous pointing operation is executed on the upper left and right corners on the touch pad 16.

As regards the ON function, the same combination of positions as in the case of the OFF function may be selected. In addition, like the OFF function, one of a plurality of preset combinations of plural positions may be selected. Furthermore, operations, other than the simultaneous pointing operations on plural positions of the touch pad 16, may be selected. Such operations include simultaneous pressing of pad buttons (two buttons disposed on the lower side of the touch pad 16), double-click (button), and double-click (pad operation).

The CPU 111 stores the setting content, which is set through the touch pad setting screen, as touch pad control data 113d (block B3, B4). In the case where the touch pad control data 113d is set by the utility 113b, the driver 113c determines whether an operation for instructing the execution of the specific function has been performed or not, by referring to the setting content in the touch pad control data 113d (FIG. 5, block A3, A10).

In the meantime, use may be made of other combinations of plural positions, than the combinations of plural positions which are presented on the touch pad setting screen shown in FIG. 8. For example, a combination of an upper right corner and a lower left corner, as shown in FIG. 9A, or a combination of a lower right corner and an upper left corner, as shown in FIG. 9B, may be used.

In the above description, the combinations of two positions have been described. Alternatively, a combination of three or more positions may be used. For instance, as a combination of three or more positions, use may be made of a combination of an upper right corner position, an upper left corner position and a lower left corner position, as shown in FIG. 10A, or a combination of an upper right corner position, a lower right corner position and an upper left corner position, as shown in FIG. 10B.

It is possible that the simultaneous pointing operation on two positions on the touch pad 16 is adopted as an operation in a specific application. However, the simultaneous pointing operation on three or more positions on the touch pad 16 is less likely adopted as an operation in a specific application, and the possibility of an erroneous operation can be made still lower than in the case of the combination of two positions.

As regards the combinations of plural positions shown in FIG. 9 and FIG. 10, these combinations may also be set through the touch pad setting screen by the utility 113b.

In the above-described manner, the combinations of plural positions for executing the specific function can arbitrarily be set by the user. Thereby, an environment with high usability for every user can be provided.

In the above description, in the case where the pointing operation is simultaneously executed on plural positions, the four corners of the touch pad 16 are pointed. Alternatively, combinations of plural positions including positions, other than the four corners, may be set. For example, combinations between corner positions and positions near the center of the touch pad 16 may be used. Positions, other than the four corners, may arbitrarily be set by the user. In this case, a region is set for determining that such a position has been pointed, and it is determined, in the touch pad control process, whether the input coordinate data is included in this region or not (FIG. 5, block A2, A9).

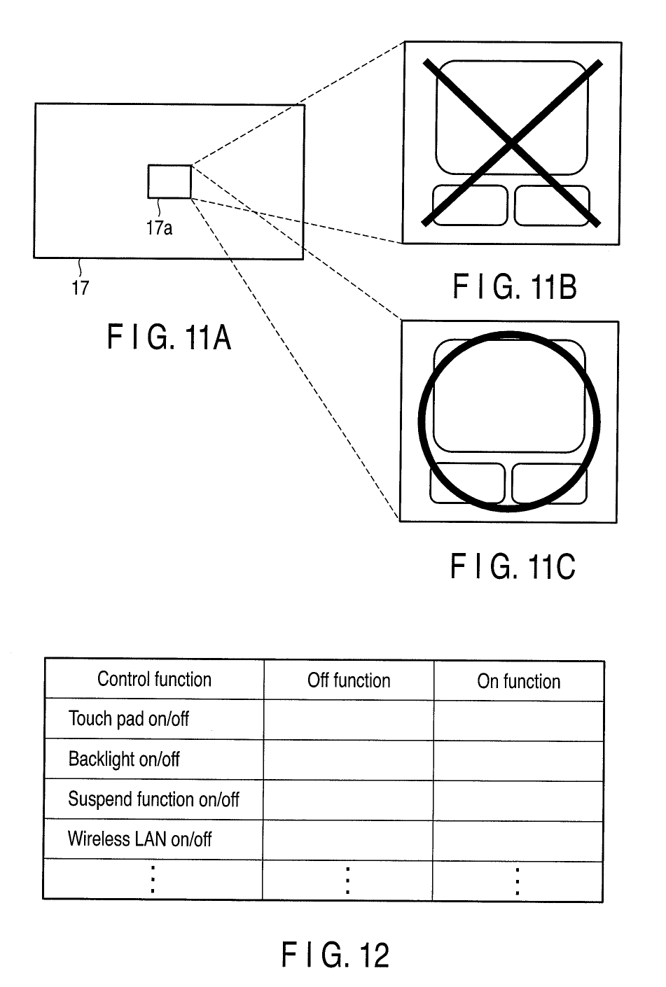

In the case where the specific function is executed by the pointing operation on plural positions of the touch pad 16, an output may be produced to inform the user of the operation condition of this function. For example, in the case where the ON/OFF of the touch pad 16 is switched as the specific function, display for positively indicating the ON/OFF state of the touch panel 16 is effected to enable the user to easily determine the ON/OFF state of the touch panel 16. For example, in an example of the display screen of the LCD 17 shown in FIG. 11A, display is effected, in the central part of the screen, for indicating the OFF state of the touch pad 16, as shown in FIG. 11B, or display is effected for indicating the ON state of the touch pad 16, as shown in FIG. 11C. In the case where control to switch the ON/OFF state of the touch panel 16 has been executed, the CPU 111 causes the LCD 17 to effect the display shown in FIG. 11B or FIG. 11C for a predetermined time, thereby making the user to recognize the operation state.

Instead of temporarily effecting the display on the central part of the display screen as shown in FIG. 11, the display may always be effected on a predetermined position of the screen. Besides, not only the report by display, but also the report by an audio output may be executed to indicate the switching of the operation state.

In the above-described example, the ON/OFF of the touch pad 10 is controlled. Alternatively, other functions that are provided in the personal computer 10 may be controlled by the simultaneous pointing operation on plural positions of the touch pad 16.

For example, the utility 113b may control functions other than the ON/OFF control function on the touch pad 16, for instance, the ON/OFF control of the backlight of the LCD 17, the ON/OFF control of the suspend function and the ON/OFF control function of the wireless LAN.

The CPU 111 executes the utility 113b, thereby setting the combinations of plural positions, on which the pointing operation is to be simultaneously executed on the touch pad 16, in order to execute the OFF function/ON function relating to the above-described respective control functions through the touch pad setting screen. As shown in FIG. 12, the CPU 111 stores, as the touch pad control data 113d, the combinations of plural positions associated with the ON function/OFF function, which are set for the respective control functions.

In the touch pad control process, the CPU 111 refers to the setting content that has been set as the touch pad control data shown in FIG. 12, thereby determining the pointing on the touch pad 16 and executing the specific function (in this example, the OFF function/ON function) in the case where the associated operation has been executed.

In the above-described example, in the case where plural positions have been simultaneously detected by the touch pad 16, the specific function that is assigned to these plural positions is executed. Alternatively, a function may be provided for measuring a time period during which the plural positions are simultaneously detected. The specific function may be executed by determining that the time period measured by this function has exceeded a preset time period (e.g. 0.5 second). Thereby, even if plural positions, which are set in the touch pad control data 113d, are erroneously pointed simultaneously, the specific function is not executed unless the measured time exceeds a predetermined time period, and it becomes possible to prevent erroneous execution of an operation which is not intended by the user.

As has been described above, in the personal computer 10 according to the present embodiment, there can be provided the function of switching, e.g. the ON/OFF of the input on the touch pad 16 by the operation of simultaneously pointing plural positions on the touch pad 16, without providing a dedicated input/output device for controlling the input on the touch pad 16.

The process that has been described in connection with the present embodiment may be stored as a computer-executable program in a recording medium such as a magnetic disk (e.g. a flexible disk, a hard disk), an optical disk (e.g. a CD-ROM, a DVD) or a semiconductor memory, and may be provided to various apparatuses. The program may be transmitted via communication media and provided to various apparatuses. The computer reads the program that is stored in the recording medium or receives the program via the communication media. The operation of the apparatus is controlled by the program, thereby executing the above-described process.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a touch pad configured to detect a plurality of positions of objects on the touch pad;
a determination module configured to determine whether a predetermined function is assigned to a combination of the plurality of positions; and
an execution module configured to execute the predetermined function when the determination module determines that the predetermined function is assigned to the combination of the plurality of positions.

2. The electronic apparatus of claim 1, further comprising a setting module configured to set the combination of the plurality of positions,
wherein the determination module is configured to determine whether the detected plurality of positions corresponds to the set combination of the plurality of positions.

3. The electronic apparatus of claim 2, wherein the predetermined function comprises a plurality of functions and the setting module is configured to set combinations of the plurality of positions which correspond to the plurality of functions.

4. The electronic apparatus of claim 1, further comprising:
a timer configured to measure a time during which the plurality of positions are detected; and
a time determination module configured to determine whether the time measured by the timer exceeds a predetermined time,
wherein the execution module is configured to execute the predetermined function when the time determination module determined that the measured time exceeds the predetermined time.

5. The electronic apparatus of claim 1, wherein the predetermined function comprises a switching function configured to switch between enabling and disabling of an input on the touch pad, the function is assigned to the combination of the plurality of positions, and
the execution module is configured to execute the switching function.

6. The electronic apparatus of claim 1, further comprising an output module configured to output an operation condition of the predetermined function.

7. A control method for a touch pad, comprising:
detecting a plurality of positions of objects on the touch pad;
determining whether a predetermined function is assigned to a combination of the detected plurality of positions; and
executing the predetermined function when it is determined that the predetermined function is assigned to the combination of the plurality of positions.
